(19) United States
(12) Patent Application Publication
(10) Pub. No.: US 2011/0309027 A1
(43) Pub. Date: Dec. 22, 2011

(54) METHOD FOR DEGRADING CHLORINATED-ORGANIC POLLUTANT

(76) Inventors: Chih-Ming Kao, Kaohsiung City (TW); Tzai-Tang Tsai, Kaohsiung City (TW); Rao Y. Surampalli, Kaohsiung City (TW)

(21) Appl. No.: 12/817,671

(22) Filed: Jun. 17, 2010

(51) Int. Cl. C02F 1/72; A62D 3/38; A62D 3/34; C02F 1/00

(52) U.S. Cl. 210/698; 210/696

(57) ABSTRACT

A method for degrading chlorinated-organic pollutant comprises the steps of providing a chlorinated-organic pollutant contaminated medium having at least one chlorinated-organic pollutant of high concentration; adding a biodegradable surfactant into the chlorinated-organic pollutant contaminated medium to enable the chlorinated-organic pollutant of high concentration to reduce surface tension and increase solubility, and makes the chlorinated-organic pollutant of high concentration dissolve in water easily; adding a persulfate (S₂O₈²⁻) into the chlorinated-organic pollutant contaminated medium; and adding a slag powder into the chlorinated-organic pollutant contaminated medium to produce a plurality of transition metal ions, and the transition metal ions catalyze the persulfate to generate sulfate radical (SO₄⁻. ) to oxidize the chlorinated-organic pollutant of high concentration of the chlorinated-organic pollutant contaminated medium.

### FIELD OF THE INVENTION

The present invention is generally relating to a method for degrading chlorinated-organic pollutant, more particularly to a method to increase degradation rate by means of surfactant and slag.

### BACKGROUND OF THE INVENTION

In recent years, groundwater being contaminated by chlorinated-organic pollutant tends to be a more serious and common problem. Therefore, chemical oxidation has been utilized for decomposition of chlorinated-organic pollutant. However, chlorinated-organic pollutant has low dissolubility so that contaminated groundwater is difficult to be decomposed. Besides, the distribution of groundwater is quite complicated that limits chemical medicament to merely decompose the chlorinated-organic pollutant distributed in source zone and core zone of a plume rather than in distal zone of a plume.

### SUMMARY

A primary object of the present invention is to offer a method for degrading chlorinated-organic pollutant comprises the steps of: providing a chlorinated-organic pollutant contaminated medium having at least one chlorinated-organic pollutant of high concentration; adding a biodegradable surfactant into the chlorinated-organic pollutant contaminated medium to enable the chlorinated-organic pollutant of high concentration to reduce surface tension and increase solubility, and makes the chlorinated-organic pollutant of high concentration dissolve in water easily; adding a persulfate (S₂O₈²⁻) into the chlorinated-organic pollutant contaminated medium; and adding a slag powder into the chlorinated-organic pollutant contaminated medium to produce a plurality of transition metal ions, and the transition metal ions catalyze the persulfate (S₂O₈²⁻) to generate sulfate radical (SO₄⁻□) to oxidize the chlorinated-organic pollutant of high concentration of the chlorinated-organic pollutant contaminated medium. This invention integrates the surfactant, the persulfate (S₂O₈²⁻) and the slag powder to apply to chemical oxidation treatment of the chlorinated-organic pollutant contaminated medium. Owing to the surfactant enables the chlorinated-organic pollutant of high concentration to reduce surface tension and increase solubility, and the slag powder is utilized to accelerate chemical oxidation of the persulfate therefore effectively extending degradation area and decreasing degradation cost.

### DESCRIPTION OF THE DRAWINGS

FIG. 1 is a flow chart illustrating a method for degrading chlorinated-organic pollutant in accordance with an embodiment of the present invention.

FIG. 2A is a PCE degradation curve by allocating different ratios of persulfate, surfactant and flag powder in accordance with the embodiment of the present invention; Conditions: [PCE]₀20 mgL⁻¹, slag dosages=10 gL⁻¹, initial pH 5.3±0.2.

FIG. 2B is a persulfate decomposition curve by allocating different ratios of persulfate, surfactant and flag powder in accordance with the embodiment of the present invention; Conditions: [PCE]₀≈20 mgL⁻¹, slag dosages=10 gL⁻¹, initial pH 5.3±0.2.

FIG. 3A is a Cl⁻ ion concentration curve by allocating different ratios of persulfate, surfactant and flag powder in accordance with the embodiment of the present invention; Conditions: [PCE]₀≈20 mgL⁻¹, slag dosages=10 gL⁻¹, initial pH 5.3±0.2.

FIG. 3B is an avg. Cl⁻ ion mass balance curve by allocating different ratios of persulfate, surfactant and flag powder in accordance with the embodiment of the present invention; Conditions: [PCE]₀≈20 mgL⁻¹, slag dosages=10 gL⁻¹, initial pH 5.3±0.2.

FIG. 4 is a PCE degradation curve with effect of slag addition in accordance with the embodiment of the present invention; [PCE]₀≈20 mgL⁻¹, [Tween80]₀≈0 mgL⁻¹, initial pH 5.3±0.2.

FIG. 5A is a PCE degradation curve by allocating different ratios of persulfate and flag powder in accordance with the embodiment of the present invention; Conditions: [PCE]₀≈20 mgL⁻¹, [Tween80]₀≈0 mgL⁻¹, slag dosages=10 gL⁻¹, initial pH 5.3±0.2.

FIG. 5B is a first-order reaction rate constant curve from PCE degradation by allocating different ratios of persulfate and flag powder in accordance with the embodiment of the present invention; Conditions: [PCE]₀≈20 mgL⁻¹, [Tween80]₀≈°mgL⁻¹, slag dosages=10 gL⁻¹, initial pH 5.3±0.2.

### DETAILED DESCRIPTION OF THE INVENTION

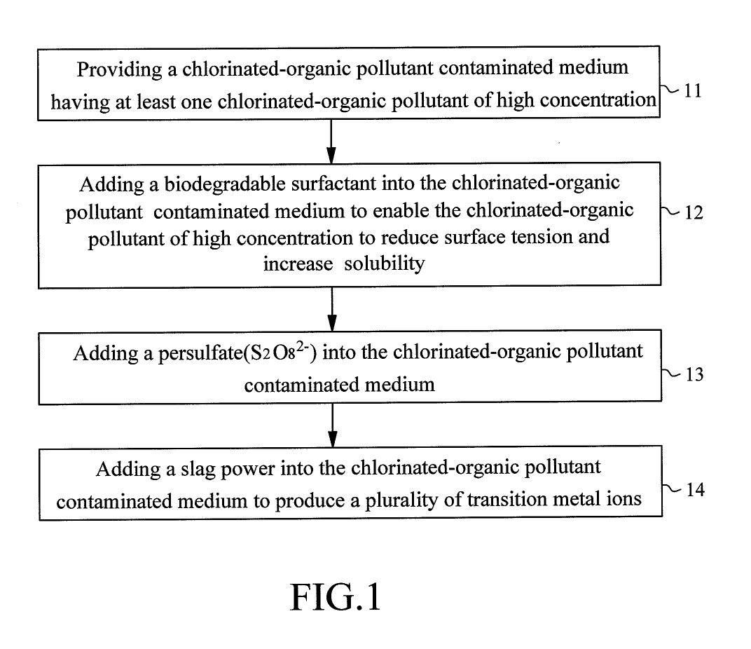

Referring to FIG. 1, a method for degrading chlorinated-organic pollutant in accordance with an embodiment of this invention comprises the steps of: with reference to step 11, providing a chlorinated-organic pollutant contaminated medium having at least one chlorinated-organic pollutant of high concentration. In this embodiment, the chlorinated-organic pollutant contaminated medium could be groundwater or industrial effluent, besides, the concentration of the chlorinated-organic pollutant contaminated medium is 10-160 mg/L; with reference to step 12, adding a biodegradable surfactant into the chlorinated-organic pollutant contaminated medium to enable the chlorinated-organic pollutant of high concentration to reduce surface tension and increase solubility, and makes the chlorinated-organic pollutant of high concentration dissolve in water easily. In this embodiment, the surfactant is Polysorbate 80 (Tween 80), and the chlorinated-organic pollutant of high concentration could be perchloroethylene, trichloroethylene, dichloroethylene or vinyl chloride; with reference to step 13, adding a persulfate (S₂O₈²⁻) into the chlorinated-organic pollutant contaminated medium. In this embodiment, the persulfate is Sodium persulfate (Na₂S₂O₈); with reference to step 14, adding a slag powder into the chlorinated-organic pollutant contaminated medium to produce a plurality of transition metal ions, wherein the particle size of the slag powder is not greater than 100 mesh and concentration of the slag powder is 5-10 g/L. The transition metal ions are ferrous ions and catalyze the persulfate to generate sulfate radical (SO₄⁻□) therefore oxidizing the chlorinated-organic pollutant of high concentration of the chlorinated-organic pollutant contaminated medium. The persulfate is a strong oxidizer so as to decompose chlorinated-organic compounds, besides, the persulfate is capable of being decomposed and generates sulfate radical via activation reaction of the transition metal ions consequently accelerating the speed to decompose chlorinated-organic compounds. This invention integrates the surfactant, the persulfate and the slag powder to apply to chemical oxidation treatment of the chlorinated-organic pollutant contaminated medium. The surfactant enables the chlorinated-organic pollutant of high concentration to reduce surface tension and increase solubility, and the slag powder is utilized to accelerate chemical oxidation of the persulfate therefore effectively having extended degradation area, cost reduction, higher degrading efficiency and environmental consciousness.

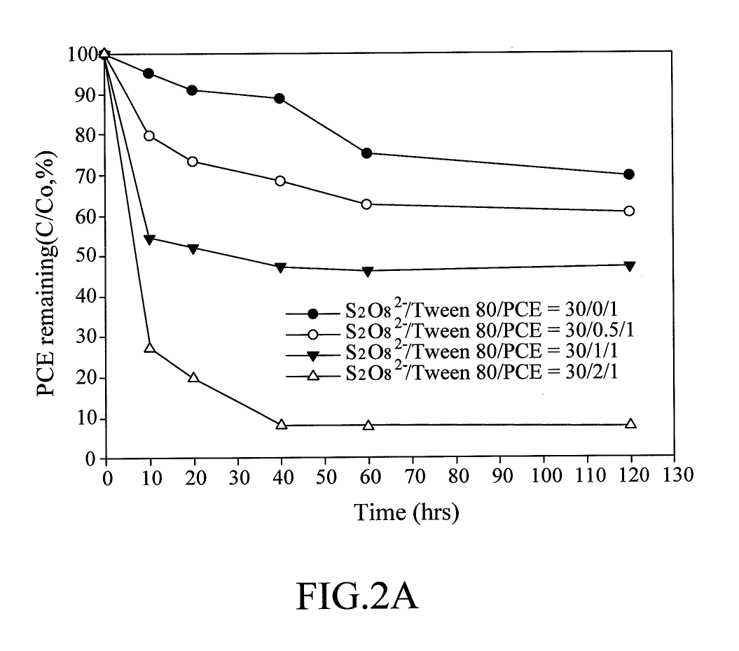

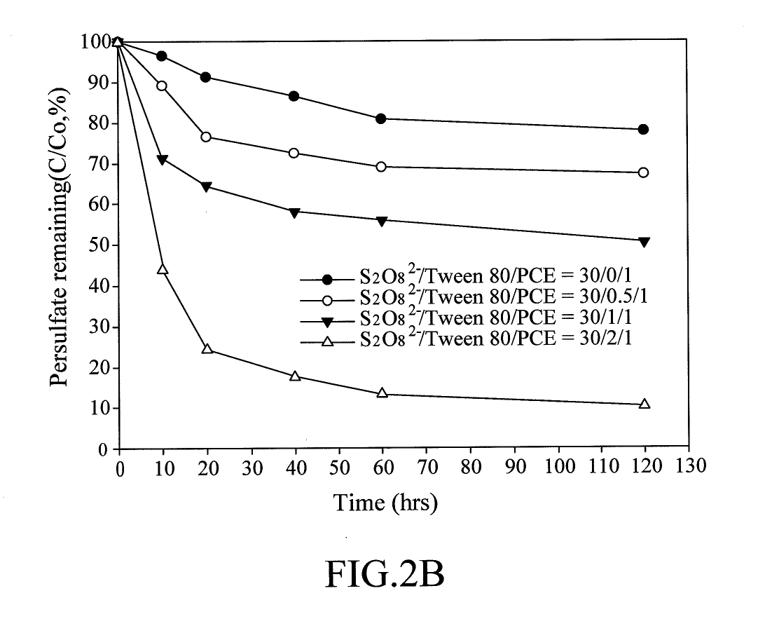

Referring to FIG. 2A to 5B, perchloroethylene (PCE) is the most representative compound in chlorinated-organic compounds. Therefore, organic pollutant of the chlorinated-organic pollutant contaminated medium in this invention is perchloroethylene, and the surfactant is polysorbate 80. This invention utilizes 200 mL of groundwater with addition of the slag powder (2 g, 10 g/L) and follows mentioned procedure to execute this experiment. With reference to FIGS. 2A and 2B, concentration of perchloroethylene is 20 mg/L and initial concentration of polysorbate 80 is 315 mg/L. This oxidation experiment is in process in accordance with several molar ratios of S₂O₈²⁻/Tween 80/PCE. When molar ratios of S₂O₈²⁻/Tween 80/PCE are 30/0/1, 30/0.5/1, 30/1/1 and 30/2/1 respectively, degradation rates are 31, 40, 53 and 92% respectively, and first-order reaction rates are 3.1×10⁻³, 8.7×10⁻³, 1.6×10⁻², 5.8×10⁻² h⁻¹ respectively, wherein when concentration of polysorbate 80 is getting higher, degradation rate of perchloroethylene and consumption rate of the persulfate increases as well. This experiment verified that degradation rate of perchloroethylene and first order reaction rate increase with increase of concentration of polysorbate 80.

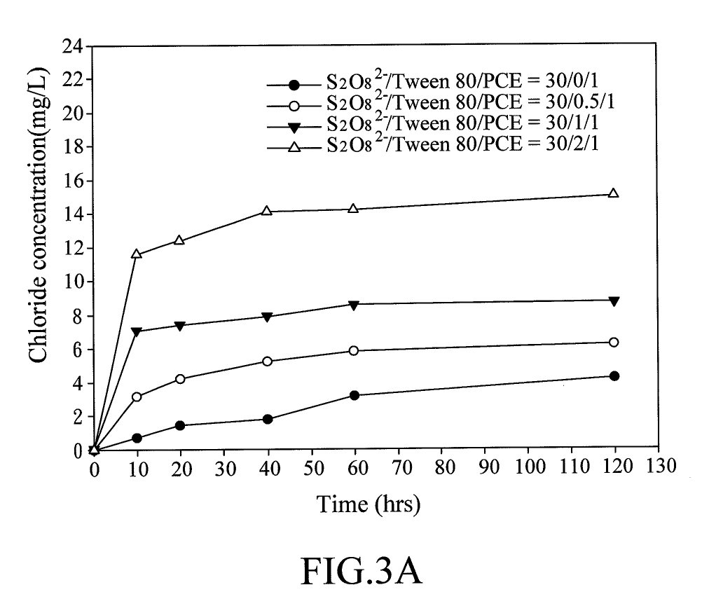

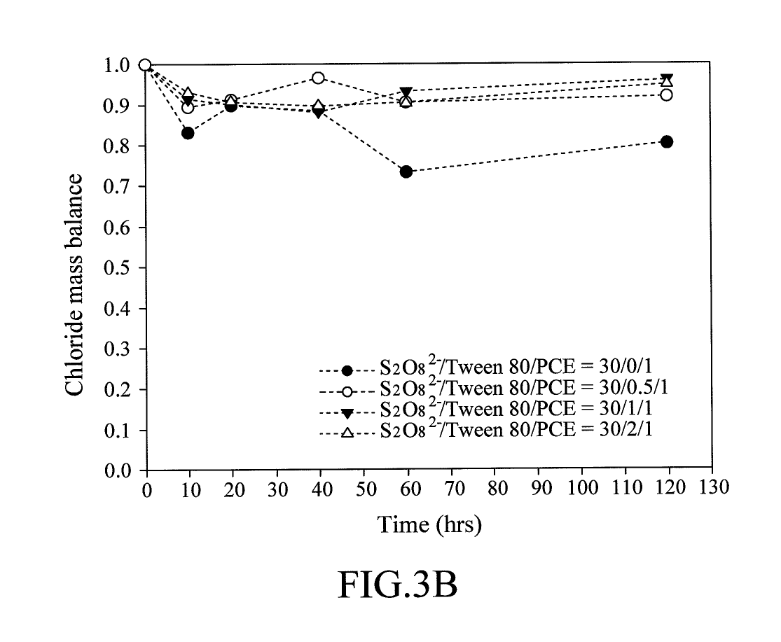

Referring to FIGS. 3A and 3B, Cl⁻ ions are products on persulfate oxidation of perchloroethylene. Consequently this invention also monitors concentration of Cr ions to evaluate the oxidation effect of combination of the surfactant and the persulfate, if initial PCE concentration is 20 mg/L, theoretical production would be 17.1 mg/L. The research indicates when molar ratios of S₂O₈²⁻/Tween 80/PCE are 30/0/1, 30/0.5/1, 30/1/1 and 30/2/1 respectively, Cr ion mass balance (actual concentration of CF ions/theoretical concentration of CF ions) is within 0.73 to 0.96.

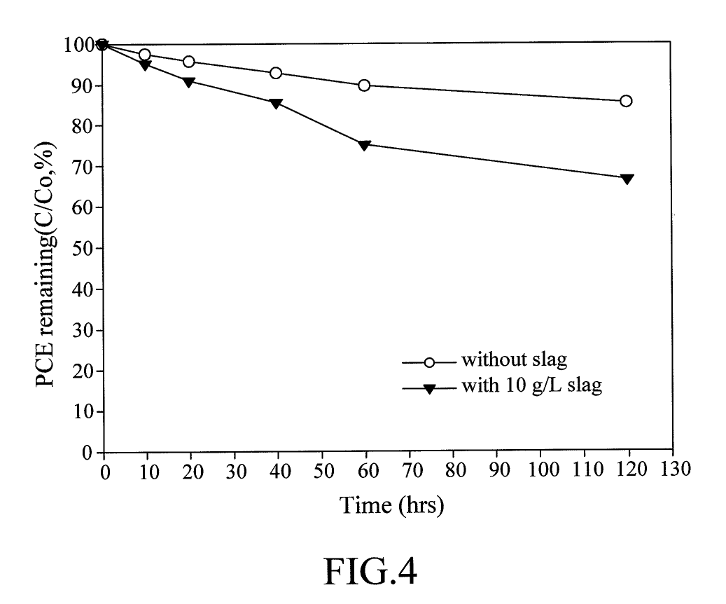

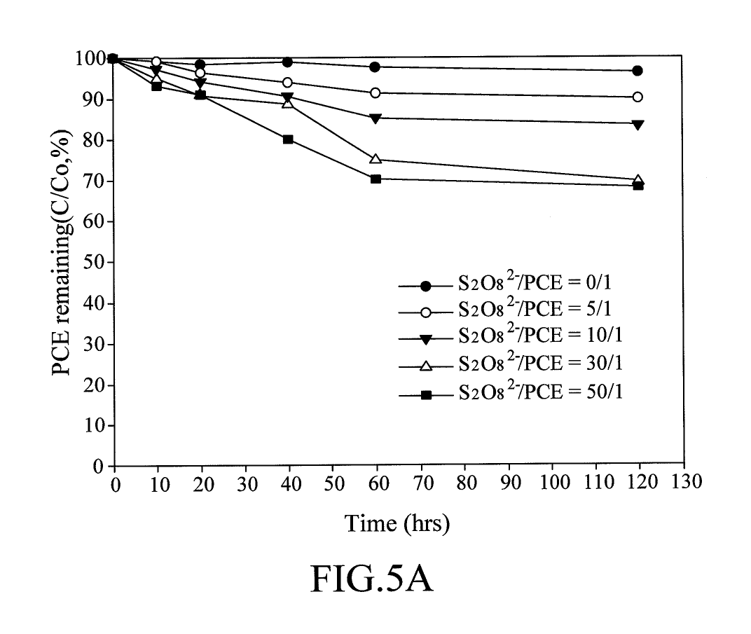

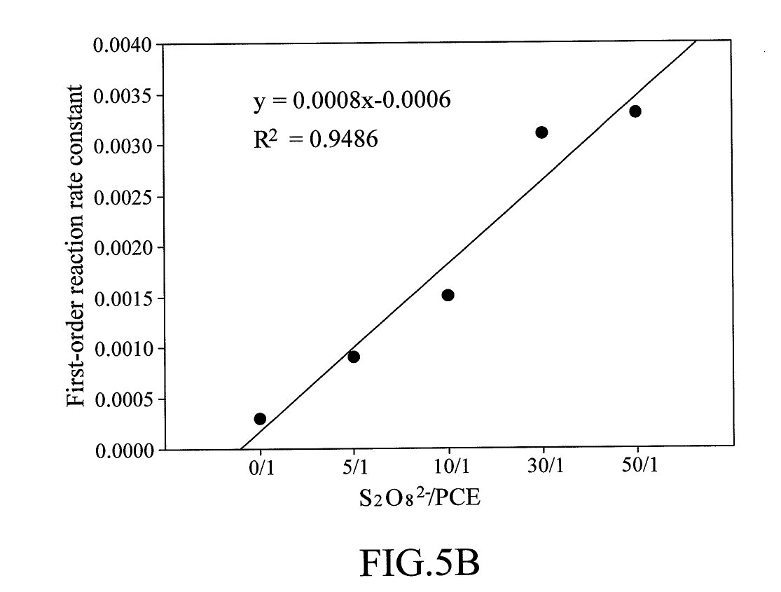

Referring to FIG. 4, this invention also put emphasis on experiment with no addition of the slag powder and polysorbate 80. FIG. 4 indicates degradation rate of perchloroethylene is merely 15%. After addition of the slag powder (with no addition of polysorbate 80), degradation rate of perchloroethylene is up to 31% (S₂O₈²⁻/Tween 80/PCE=30/0/1). This experiment indicates ferrous ions being contained in the slag powder certainly enable the persulfate to have higher oxidation ability in the chlorinated-organic pollutant of groundwater. Besides, with reference to FIG. 5A to 5B, degradation rate of perchloroethylene and first order reaction rate constant increase with increase of concentration of the persulfate. The method of this invention is capable of degrading chlorinated-organic compounds completely and enabling residues of lethal toxicity products (such as trichloroethylene, dichloroethylene and vinyl chloride) to be difficult to remain.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

1. A method for degrading chlorinated-organic pollutant comprising:
providing a chlorinated-organic pollutant contaminated medium having at least one chlorinated-organic pollutant of high concentration;
adding a biodegradable surfactant into the chlorinated-organic pollutant contaminated medium to enable the chlorinated-organic pollutant of high concentration to reduce the surface tension and increase the solubility, and makes the chlorinated-organic pollutant of high concentration dissolve in water easily;
adding a persulfate (S₂O₈²⁻) into the chlorinated-organic pollutant contaminated medium; and
adding a slag powder into the chlorinated-organic pollutant contaminated medium to produce a plurality of transition metal ions, and the transition metal ions catalyze the persulfate to generate sulfate radical (SO₄⁻.) to oxidize the chlorinated-organic pollutant of high concentration of the chlorinated-organic pollutant contaminated medium.

2. The methods for degrading chlorinated-organic pollutant in accordance with claim 1, wherein the transition metal ions are ferrous ions (Fe²⁺).

3. The methods for degrading chlorinated-organic pollutant in accordance with claim 1, wherein the surfactant is polysorbate 80 (Tween 80).

4. The methods for degrading chlorinated-organic pollutant in accordance with claim 1, wherein the particle size of the slag powder is not greater than 100 mesh.

5. The methods for degrading chlorinated-organic pollutant in accordance with claim 1, wherein the chlorinated-organic pollutant contaminated medium could be groundwater or industrial effluent.

6. The methods for degrading chlorinated-organic pollutant in accordance with claim 1, wherein the chlorinated-organic pollutant of high concentration could be perchloroethylene, trichloroethylene, dichloroethylene or vinyl chloride.

7. The methods for degrading chlorinated-organic pollutant in accordance with claim 1, wherein the persulfate is sodium persulfate (Na₂S₂O₈).
